(19) United States
(12) Patent Application Publication
(10) Pub. No.: US 2017/0098851 A1
(43) Pub. Date: Apr. 6, 2017

(54) FLOW BATTERY CELLS AND STACKS, AND ASSOCIATED METHODS

(71) Applicant: General Electric Company, Schenectady, NY (US)

(72) Inventors: Sergei Kniajanski, Clifton Park, NY (US); Guillermo Daniel Zappi, Troy, NY (US); Grigorii Lev Soloveichik, Reston, VA (US)

(21) Appl. No.: 14/875,998

(22) Filed: Oct. 6, 2015

(51) Int. Cl. H01M 8/20; H01M 4/90; H01M 8/18; H01M 8/08

(52) U.S. Cl. CPC H01M 8/20; H01M 8/08; H01M 4/9016; H01M 8/188; H01M 2300/0002; H01M 2250/20

(57) ABSTRACT

A flow battery cell is presented. The flow battery cell includes a first electrode configured for charging a discharged catholyte, a second electrode configured for charging and discharging an anolyte, and a third electrode configured for discharging a charged catholyte. The second electrode is disposed between the first electrode and the third electrode. Each of the first electrode and the third electrode is separated from the second electrode by a bipolar membrane. A first bipolar membrane and a second bipolar membrane are disposed, respectively, between the first electrode and the second electrode, and the second electrode and the third electrode. A flow battery stack and a method for operating the flow battery stack are also presented.

### BACKGROUND

The present disclosure generally relates to flow batteries. More specifically, the present disclosure relates to configurations and designs of the flow battery cell or stack.

Flow batteries having the potential for increased energy density are desirable for a variety of end uses. Redox (oxidation-reduction) flow batteries (RFB's) may be suitable candidates for grid-scale electrical energy storage (EES) and electrical vehicles (EV), due, at least in part, to their ability to separate power and energy, flexible layout, safety aspects, and potential cost effectiveness.

In conjunction with the flexibility allowed by the flow battery, relative cost-effectiveness of the battery's chemical components may be another desirable attribute. A typical RFB includes a stack of flow battery cells, each having an ion-exchange membrane disposed between a cathode and an anode. During operation, a catholyte flows through the cathode, and an anolyte flows through the anode. The catholyte and anolyte solutions electrochemically react separately in the reversible reduction-oxidation (“redox”) reactions. During the redox reactions, ionic species are transported across the ion-exchange membrane, and electrons are transported through an external circuit to complete the electrochemical reactions.

A commonly known RFB is a zinc-bromine flow battery. Another potential example may be a zinc-chlorate flow battery. The use of a multielectron chlorate cathode may result in a higher energy density and lesser safety issues, as compared to the use of other energy-dense cathodes, for example, bromine. The electrochemical reaction of the zinc chlorate flow battery requires precise pH control to maintain high reaction efficiency. However, in currently available flow battery configurations, the use of proton exchange membranes may be inefficient in selective transportation of protons, which results in a pH imbalance during the electrochemical reaction in the cells. Efforts have been made to achieve the optimal pH, for example by the addition of a buffer to the anolyte. However, these techniques may affect some other performance features of the flow batteries.

Thus, there is a need for new configurations of flow battery cells or stacks, which may, for example, allow for pH balance in the flow batteries.

### BRIEF DESCRIPTION

One embodiment of the invention is directed to a flow battery cell. The flow battery cell includes a first electrode configured for charging a discharged catholyte, a second electrode configured for charging and discharging an anolyte, and a third electrode configured for discharging a charged catholyte. The second electrode is disposed between the first electrode and the third electrode. Each of the first electrode and the third electrode is separated from the second electrode by a bipolar membrane. A first bipolar membrane and a second bipolar membrane are disposed, respectively, between the first electrode and the second electrode, and the second electrode and the third electrode.

One embodiment is directed to a flow battery stack that includes an electrode array. The electrode array includes a plurality of first electrodes configured for charging a discharged catholyte; a plurality of second electrodes configured for charging and discharging an anolyte; and a plurality of third electrodes configured for discharging a charged catholyte. Each first electrode in the plurality of the first electrodes is disposed in an alternating manner with respect to each third electrode in the plurality of the third electrodes, and each second electrode in the plurality of second electrodes is disposed between a first electrode and a third electrode pair. The flow battery stack further includes a plurality of first bipolar membranes, wherein each first bipolar membrane in the plurality of the first bipolar membranes is disposed between a first electrode and a second electrode pair in the electrode array; and a plurality of second bipolar membranes, wherein each second bipolar membrane in the plurality of second bipolar membranes is disposed between a second electrode and a third electrode pair in the electrode array.

In one embodiment, a method for operating the flow battery stack is provided. The method includes charging the flow battery stack by contacting the discharged catholyte with at least one first electrode in the plurality of first electrodes and the anolyte with at least one second electrode in the plurality of second electrodes. The method further includes discharging the flow battery stack by contacting the anolyte with at least one second electrode in the plurality of second electrodes and the charged catholyte with at least one third electrode in the plurality of third electrodes. The at least one first electrode, the at least one second electrode, and the at least one third electrode constitute at least one flow battery cell in the flow battery stack.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a graph showing a variation of pH in a cathode with the state of charge during an electrochemical reaction in a conventional cell including a proton conducting membrane;

FIG. 2 is a simplified schematic of a flow battery cell, in accordance with some embodiments;

FIG. 3 is a simplified schematic of a flow battery cell during charging, in accordance with some embodiments;

FIG. 4 is a simplified schematic of a flow battery cell during discharging, in accordance with some embodiments;

FIG. 5 is a simplified schematic of a flow battery stack, in accordance with some embodiments;

FIG. 6 is a simplified schematic of a flow battery stack during charging, in accordance with some embodiments;

FIG. 7 is a simplified schematic of a flow battery stack during discharging, in accordance with some embodiments.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and claims, the singular forms “a”, “an” and “the” include plural referents unless the context clearly dictates otherwise. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

The term “catholyte” as used herein refers to an electrolyte disposed adjacent to a cathode in an electrolytic cell, and the term “anolyte” as used herein refers to an electrolyte disposed adjacent to an anode of the electrolytic call. The catholyte and the anolyte usually include one or more electrochemically active species that are oxidized or reduced under battery cell conditions. As used herein, the terms “charged catholyte” and “discharged catholyte” refer, respectively, to the oxidized and reduced forms of the electrochemically active species that are present in the catholytes in the charged state and the discharged state of the cell.

In a flow battery (sometimes also referred to as a flow-assisted battery), the cathode and anode of a battery cell, usually include a catholyte and an anolyte, respectively, separated by an ion-permeable membrane such as a proton exchange membrane (PEM). One example of a flow battery is a metal-halate battery. In the charged state of a metal-halate battery, the catholyte may include a solution of at least one halate salt in the cathode, and the anolyte may include a metal or metal alloy in combination with a source of an anion which is needed to form a metal salt upon the anolyte electrochemical discharge. The metal or metal alloy may be disposed on or detached (for example, in slurry form) from the anode. The cell chemistry of a metal-halate cell is usually based on a reversible redox (reduction-oxidation) reaction that involves the conversion of the halate to the corresponding halide ion. The metal or metal alloy is capable of being dissolved into the metal salt, for example a metal halide or metal acetate, during the redox reaction.

In a metal-chlorate cell, it is possible to use the same metal cation in both the anode and cathode, due to the high solubility of metal chlorates and chlorides. On the catholyte side, a metal chlorate is converted to the corresponding metal chloride (chlorate-to-chloride conversion) during discharging, while the chloride-to-chlorate reaction occurs during charging the cell. On the anolyte side, metal ions are converted to the respective metal itself (i.e., elemental metal) during charging; while the metal is dissolved into a corresponding salt, such as the chloride salt or the acetate salt, during discharge of the cell. Non-limiting example of such a halate/halide battery is described in a previously filed application, Publication No. WO2014197842.

Further, during discharging, the halate ion (for example, chlorate) consumes six electrons and six protons to generate a halide ion (for example, chloride) and three water molecules as shown in equation 1. During charging, the reaction proceeds in the reverse direction (E°=1.45 V, in the case of chlorate/chloride).

(ClO₃)⁻+6H⁺+6e⁻<==>Cl⁻+3H₂O (Equation 1)

By way of example, the overall cell reaction can be expressed by equation 2 for a zinc-chlorate cell,

Zn(ClO₃)₂+6Zn+12HCl<==>7ZnCl₂+6H₂O (Equation 2)

That is, the reversible redox reaction involves the formation of six protons per one chloride ion oxidized during charging, and consumption of six protons per one chlorate ion reduced during discharging. As mentioned earlier, pH control during charging and discharging, may be desirable to maintain a high reaction rate and cell efficiency. For example, the chloride oxidation is desirably performed at a pH of about 6.7 while the chlorate reduction is desirably performed at a pH of about 1.0.

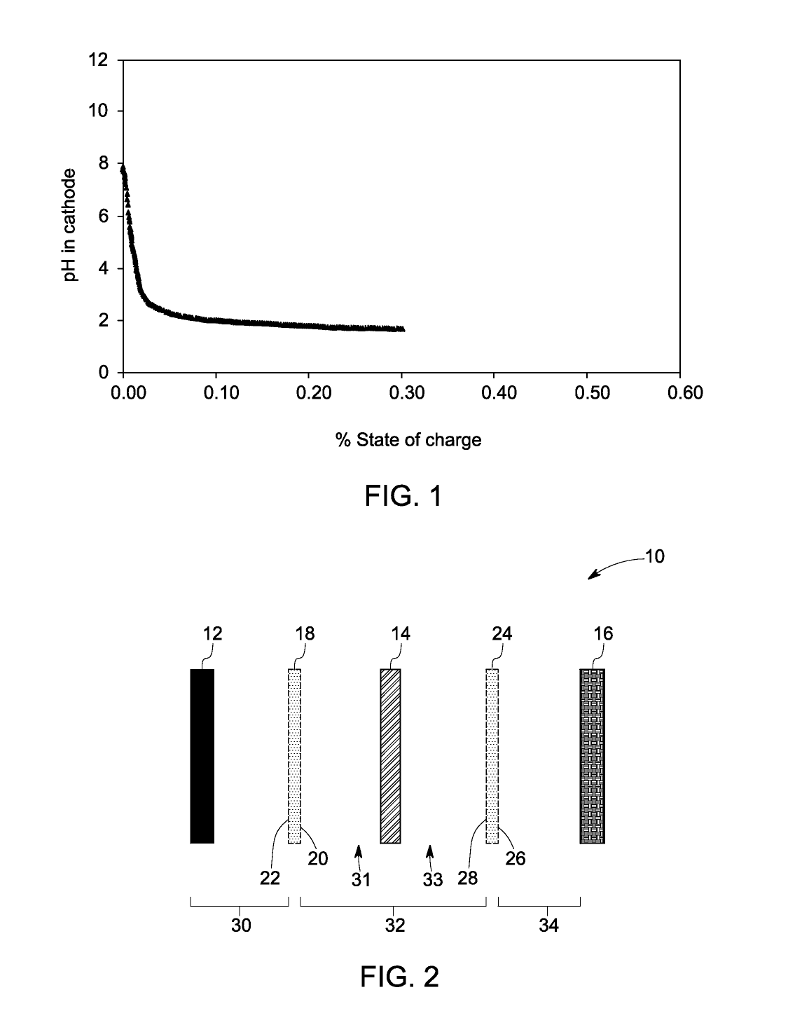

In case of an ideal proton exchange membrane, the protons are typically transferred from the catholyte to the anolyte during charging, and returned to the catholyte during discharging, thereby maintaining the pH balance. However, for proton exchange membranes typically employed in flow batteries (for example, Nafion® membranes), the competition between metal and hydrogen cations to be transferred across the membrane, may cause a pH imbalance under operating conditions. For example, the transfer rate of a metal cation Mⁿ⁺ at 3-4M (molar concentration) of the metal chloride is significantly higher (by orders of magnitude) than the transfer rate of the protons at pH ˜6-7 (10⁻⁶-10⁻⁷M). Under these conditions metal cations carry most of the charge across the membrane. As a result, the pH decreases significantly in the catholyte during charging and rapidly increases during discharging. For example, in case of a 3M sodium chloride solution in the catholyte, the pH in the catholyte rapidly decreases to less than 2.0 during charging, as shown in FIG. 1. Currently available buffers may not be suitable to neutralize such a large amount of protons or hydroxyls.

Aspects of the invention described herein address the noted shortcomings of the state of the art. Some embodiments of the invention present a flow battery cell and a flow battery stack that use a bipolar membrane to separate a catholyte and an anolyte. Use of the bipolar membrane between the catholyte and the anolyte may aid in maintaining and controlling pH of the catholyte, and may thus enable pH balance under the operating conditions of the flow battery cell.

The term “bipolar membrane” as used herein refers to an ion exchange membrane including a layered ion-exchange structure. A bipolar membrane typically includes a proton exchange layer and an anion exchange layer attached to each other. The proton exchange layer side of the membrane is usually referred to as cationic side, and the anion exchange layer side of the membrane is referred to as anionic side. As known to skilled in the art, cations cannot cross over through the anionic side and anions cannot cross over through the cationic side of the membrane. In some embodiments, small amounts of the cations and anions may pass through the anionic side and cationic side, respectively, of the bipolar membrane. The bipolar membrane splits water to protons and hydroxyl ions under the influence of an applied electric field, and protons and hydroxyl ions migrate out of the bipolar membrane in opposite directions.

The cell chemistry of the present flow battery cell and flow battery stack is based on the reversible redox (reduction-oxidation) reaction that involves the conversion of a halate to the corresponding halide ion in a similar manner as discussed above in context of the conventional cell. During discharging, the halate ion (for example, chlorate) consumes six electrons and six protons to generate a halide ion (for example, chloride) and three water molecules. Water may diffuse into the bipolar membrane and split to provide protons and hydroxyls on the interface of the proton and anion exchange layers of the bipolar membrane. In order to split water, a cationic side, that is the cation exchange layer of the bipolar membrane may be required to face the catholyte, during discharging. Furthermore, during discharging, the anionic side of the bipolar membrane may also be required to face the anolyte so that the protons generated at the cationic side of the membrane neutralize the hydroxyls formed upon the reduction of the halate. On the other hand, during charging, the halide ion oxidizes in the catholyte and generates six protons and six electrons. The pH of the catholyte may be maintained by neutralizing protons formed during charging with hydroxyls formed upon the water splitting. In order to split water, an anionic side, that is the anion exchange layer of the bipolar membrane may be required to face the catholyte, during charging.

To accommodate these features, some embodiments of the invention present a flow battery cell that includes a three-electrode configuration (also referred to as three-chamber configuration, in some embodiments), as described in greater detail below. The three-electrode configuration enables the use of the bipolar membrane between the catholyte and anolyte in the cell, and may thus aid in pH balancing during electrochemical reaction in the flow battery cell that involves generation/consumption of protons.

In one embodiment, the flow battery cell includes a first electrode configured for charging a discharged catholyte, a second electrode configured for charging and discharging an anolyte, and a third electrode configured for discharging a charged catholyte. The second electrode is disposed between the first electrode and the third electrode. Each of the first electrode and the third electrode is separated from the second electrode by a bipolar membrane. A first bipolar membrane and a second bipolar membrane are disposed, respectively, between the first electrode and the second electrode, and the second electrode and the third electrode.

The present disclosure also encompasses embodiments of, a flow battery stack that includes at least one flow battery cell and a method for operating the flow battery stack. The terms, “flow battery cell” and “cell” are used herein interchangeably, throughout the specification. The terms, “flow battery stack” and “flow battery” are used herein interchangeably, throughout the specification.

In some embodiments, an aqueous solution of a halate salt of at least one metal may be used as a charged catholyte. Non-limiting examples of suitable metals include sodium, lithium, calcium, zinc, nickel, copper or combinations thereof. The term “halate” refers to a salt of halogen oxoacid. Usually, the oxoacid compound conforms to the general formula HXO₃, where X is chlorine, bromine, or iodine. The corresponding salts are halate salts, for example the chlorate salt, the bromate salt, and the iodate salt. In some cases, the term “halate” may be used to describe any of the chlorates, bromates, iodates, or combinations thereof. In the case of chlorine, the corresponding salt of chloric acid (i.e, the chlorate) may be selected from the group consisting of sodium chlorate, potassium chlorate, lithium chlorate, calcium chlorate, magnesium chlorate, barium chlorate, zinc chlorate, copper (II) chlorate, and combinations thereof. In the case of bromine, the corresponding salt of bromic acid (i.e., the bromate) may be selected from the group consisting of sodium bromate, potassium bromate, lithium bromate, calcium bromate, magnesium bromate, zinc chlorate, and combinations thereof. In the case of iodine, the corresponding salt (i.e., the iodate) may be selected from the group consisting of potassium iodate, sodium iodate, and combination thereof.

As discussed above, in some embodiments, during a redox reaction, the metal halates are reduced to metal halides, and the metal halides are oxidized to metal halates. The energy density of a catholyte is usually determined by the molar solubility of the electrochemically active species (for example, the metal halate and the metal halide) and the number of electrons involved in the redox reaction. Due to high solubility of chlorates in water (up to about 5.5-7M) and large number of electrons transfer during the halate reduction to the halide, flow batteries based on halate/halide catholytes may have the energy density as high as 300 Wh/kg.

In some embodiments, the discharged catholyte and the charged catholyte include different anionic forms (that is, a metal halate or a metal halide). In some embodiments, the charged catholyte includes one or more metal halates (as discussed above) during discharging the flow battery cell. In certain embodiments, the charged catholyte includes a solution of at least one metal chlorate (for example, zinc chlorate). In some embodiments, the discharged catholyte includes one or more metal halides during charging the flow battery cell. In certain embodiments, the discharged catholyte includes a solution of at least one metal chloride (for example, zinc chloride).

In some embodiments, the anolyte includes an aqueous solution of at least one metal salt, when the cell is in the discharged state. Non limiting examples of suitable metal salts include a zinc salt, cobalt salt, copper salt, iron salt, manganese salt, chromium salt, vanadium salt, titanium salt, or combinations thereof. The metal salt is capable of generating a metal or a metal alloy during charging the cell. The metal or the metal alloy may be present in the form of a slurry in the anolyte of the flow battery cell, or as a sheet or layer of material attached to a surface of the second electrode. The anolyte may optionally include a buffer, for example, an ionic buffer such as an ammonia compound, or an acetate. The metal or metal alloy is capable of being dissolved in the anolyte during discharging of the cell to regenerate the metal salt.

FIG. 2 is a simplified schematic of a flow battery cell 10, according to some embodiments. The cell 10 includes a first electrode 12, a second electrode 14, and a third electrode 16. The second electrode 14 is disposed between the first electrode 12 and the third electrode 16. The first electrode 12 is configured for charging the discharged catholyte; the second electrode 14 is configured for charging and discharging the anolyte; and the third electrode 16 is configured for discharging the charged catholyte. The first electrode 12 and the second electrode 14 are separated from each other by a first bipolar membrane 18, and the second electrode 14 and the third electrode 16 are separated from each other by a second bipolar membrane 24.

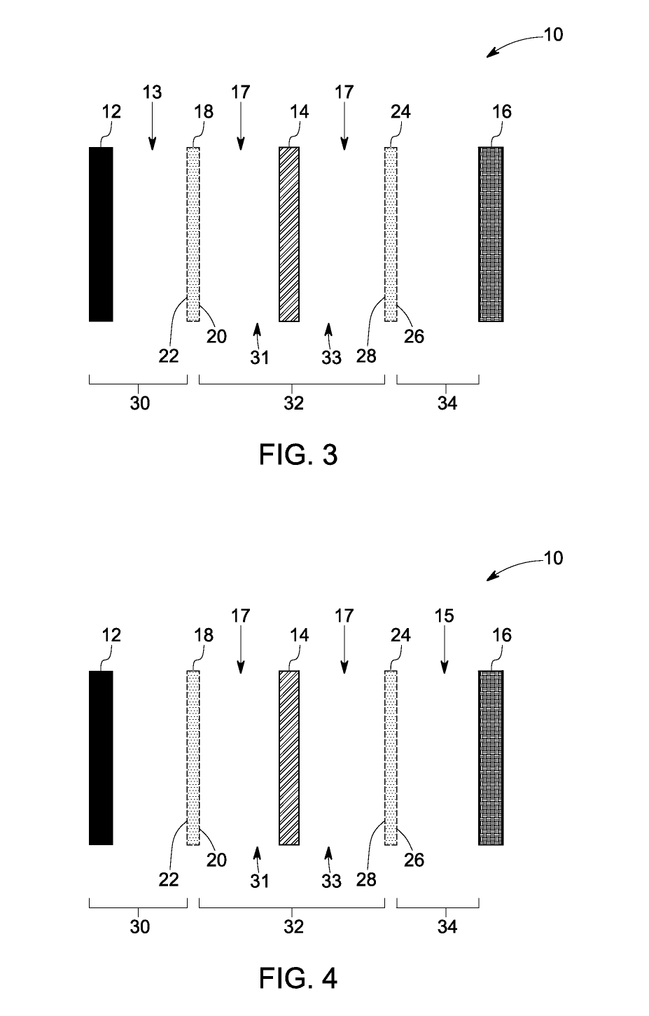

In some embodiments, as shown in FIG. 3, the flow battery cell 10 may further include a discharged catholyte 13 in contact with the first electrode 12, and an anolyte 17 in contact with the second electrode 14, for example, during charging of the cell. In some embodiments, as shown in FIG. 4, the flow battery cell 10 may further include the charged catholyte in contact with the third electrode 16 and the anolyte 17 in contact with the second electrode 14, for example, during discharging of the cell. As shown in FIGS. 3 and 4, the discharged catholyte 13, the charged catholyte 15, and the anolyte 17 may be present in the cell such that both the discharged catholyte 13 and the charged catholyte 15 are separated from the anolyte 17 by the bipolar membranes 18, 24.

Referring again to FIGS. 2, 3 and 4, the cell 10 includes a first bipolar membrane 18 disposed between the first electrode 12 and the second electrode 14; and a second bipolar membrane 24 disposed between the second electrode 14 and the third electrode 16. The first bipolar membrane 18 includes a first proton exchange layer 20 and a first anion exchange layer 22. The second bipolar membrane 24 includes a second proton exchange layer 26 and a second anion exchange layer 28. The material chemistry and the configuration of the proton exchange layers and anion exchange layers in the first bipolar membrane 18 and the second bipolar membrane 24 may be same or different. In some embodiments, the first bipolar membrane 18 and the second bipolar membrane 20 include the same proton exchange layers and anion exchange layers, that is, the material chemistry and the configuration of the exchange layers is the same in the two bipolar membranes 18, 24.

As illustrated in FIGS. 2, 3 and 4, the first bipolar membrane 18 is disposed between the first electrode 12 and the second electrode 14. Further, the first bipolar membrane 18 is disposed in the cells such that the first anion exchange layer 22 faces the first electrode 12, and the first electrode 12 and the first anion exchange layer 22 define at least a portion of a first chamber 30. Further, the second electrode 14 and the first proton exchange layer 20 define a first portion 31 of a second chamber 32. Similarly, the second bipolar membrane 24 is disposed between the second electrode 14 and the third electrode 16 such that the second anion exchange layer 28 faces the second electrode 14, and the second proton exchange layer 26 and the third electrode 16 define at least a portion of a third chamber 34. Further, the second electrode 14 and the second anion exchange layer 28 define a second portion 33 of the second chamber 32

Referring to FIG. 3, the first chamber 30 includes the first electrode 12 and the discharged catholyte 13, in some embodiments. The second chamber 32, in some embodiments, includes the second electrode 14 and the anolyte 17, as shown in FIGS. 3 and 4. In some embodiments, the third chamber 34 includes the third electrode 16 and the charged catholyte 15, as shown in FIG. 4. As illustrated, the first chamber 30 and the second chamber 32 are separated by the first bipolar membrane 18; and the second chamber 32 and the third chamber 34 are separated by the second bipolar membrane 24. The first chamber 30 including the first electrode 12 and the discharged catholyte 13, may also be referred to as “first electrode chamber” or “discharged catholyte chamber.” The second chamber 32 including the second electrode 14 and the anolyte 17, may be referred to as “second electrode chamber” or “anolyte chamber.” The third chamber 34 including the third electrode 16 and the charged catholyte 15 may be referred to as “third electrode chamber” or “charged catholyte chamber.”

The first electrode 12, the second electrode 14 and the third electrode 16 may include an electrically-conductive substrate. Non-limiting examples of suitable electrically-conductive substrates may include carbon (in a conductive form, for example graphite), a metal, or a combination thereof. Suitable metals include, but are not limited to, ruthenium, tantalum, lead, titanium, nickel, platinum, palladium, or combinations thereof. In some embodiments, the electrically-conductive substrate includes a metal oxide. Suitable metal oxide examples include, but are not limited to, ruthenium oxide, tantalum oxide, lead oxide, titanium oxide, or combinations thereof. In some embodiments, an electrocatalyst may be deposited on the electrically-conductive material in combination with an ionomer to form a liquid diffusion layer. Non-limiting examples of electrocatalysts include polyoxometalate-based materials, platinum, palladium, ruthenium, rhodium, or various alloys or compounds of the aforementioned metals. One or both of the composition and the structure of the first electrode 12 and the third electrode 16 may be the same or different. In some embodiments, the first electrode 12 and the third electrode 16 may be composed of the same composition. In certain embodiments, the first electrode 12 includes ruthenium oxide. In certain embodiments, the third electrode 16 includes ruthenium compounds. The ruthenium compounds may be desirably insoluble in aqueous solutions with a pH from about 0.8 to about 9.0.

In some embodiments, the second electrode 14 includes an electrically conductive substrate that is electrochemically inert in the electrochemical environment of the flow battery cell 10. In some embodiments, the second electrode 14 may include a three-dimensional (3D) mesh. The 3D mesh form of the second electrode 14 may be desirable so that the metal plated in the first portion 31 of the second chamber 32 during charging of the cell, is available for dissolution in the second portion 33 of the second chamber 32 during discharging of the cell.

As discussed previously, during the cell reaction of a chlorate/chloride cell, the chlorate salt is converted to a chloride salt during discharging, while the chloride-to-chlorate reaction occurs during charging. On the anolyte side, metal ions are converted to the respective metal during charging, while the metal is dissolved into a corresponding salt, such as the chloride salt, during discharging.

Referring to FIGS. 2, 3 and 4 again, in some embodiments, the charging of the cell 10 is performed using the first electrode 12 and the second electrode 14. In some embodiments, discharging of the cell is performed using the second electrode 14 and the third electrode 16. During charging, the first chamber 30 includes the discharged catholyte 13 and the second chamber 32 includes the anolyte 17, as shown in FIG. 3. In these instances, the third chamber 34 may not include the charged catholyte or the third electrode 16 remains idle. Further, in these instances, during charging, the metal halide oxidizes to metal halate, and the halide-to-halate reaction occurs in the first chamber 30; and the metal ions are converted to the respective metal in the second chamber 32.

Similarly, during discharging, the third chamber 34 includes the charged catholyte 15 and the second chamber 32 includes the anolyte 17, as shown in FIG. 4. In these instances, the first chamber 30 may not include the discharged catholyte 13 or the first electrode 12 remains idle. In these instances, during discharging, the metal halate is converted to the metal halide in the third chamber 34; and the metal is dissolved into a corresponding salt (halide salt) in the second chamber 32.

As will be apparent by the description above, in accordance with some embodiments of the invention, in the cell 10, the second chamber 32 is typically used for charging and discharging of the cell; however, different catholyte chambers (i.e., the first chamber 30 and the third chamber 34) are used for charging and discharging the cell.

Some embodiments of the invention are directed to a flow battery stack that includes an electrode array. The electrode array includes a plurality of first electrodes configured for charging a discharged catholyte; a plurality of second electrodes configured for charging and discharging an anolyte; and a plurality of third electrodes configured for discharging a charged catholyte. Each first electrode in the plurality of the first electrodes is disposed in an alternating manner with respect to each third electrode in the plurality of the third electrodes, and each second electrode in the plurality of second electrodes is disposed between a first electrode and a third electrode pair. The flow battery stack further includes a plurality of first bipolar membranes, wherein each first bipolar membrane in the plurality of the first bipolar membranes is disposed between a first electrode and a second electrode pair in the electrode array; and a plurality of second bipolar membranes, wherein each second bipolar membrane in the plurality of second bipolar membranes is disposed between a second electrode and a third electrode pair in the electrode array.

In one embodiment, the flow battery cells may be arranged in series. The number of cells in series depends on the voltage expected to be generated by the battery stack and the open circuit voltage (OCV) of the individual cell. For example, to achieve a 24 Volt battery having 2V OCV, the number of cells in the series may be 12.

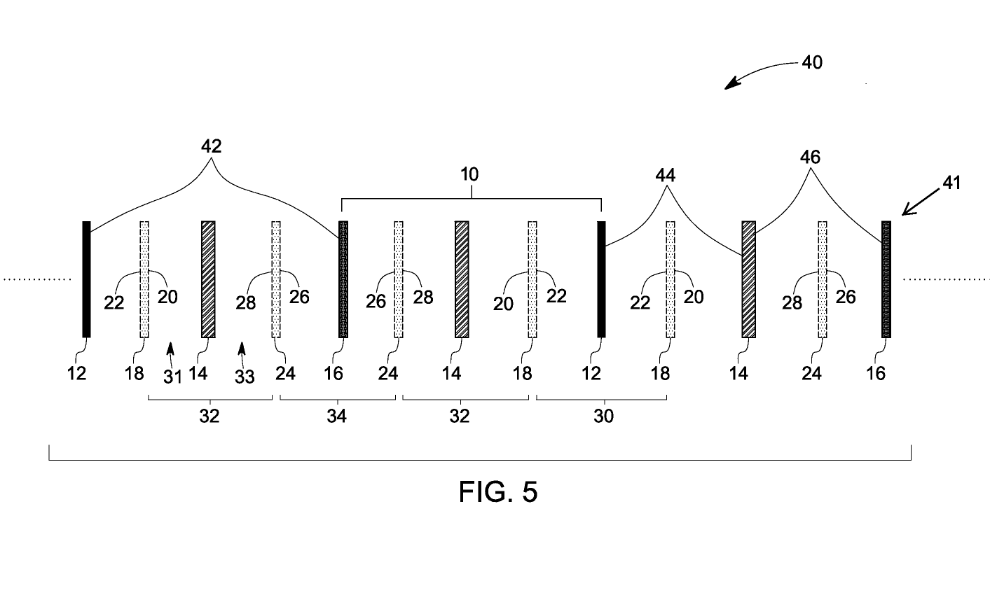

FIG. 5 is a schematic of a flow battery stack 40, according to some embodiments of the invention. Reference numerals common to the cell of FIGS. 2, 3 and 4, represent similar or identical elements. The flow battery stack 40 includes an electrode array 41 including a plurality of first electrodes 12, a plurality of second electrodes 14 and a plurality of third electrodes 16. The plurality of first electrodes 12 are configured for charging a discharged catholyte. The plurality of second electrodes 14 are configured for charging and discharging an anolyte. The plurality of third electrodes 16 are configured for discharging a charged catholyte. In the electrode array 41 of the stack 40, each first electrode 12 in the plurality of first electrodes is disposed in an alternating manner with respect to each third electrode 16 in the plurality of the third electrodes. Further each second electrode 14 in the plurality of second electrodes is disposed between a pair 42 of the first electrode 12 and the third electrode 16 (also referred to as a first electrode and third electrode pair 42).

The stack 40 further includes a plurality of first bipolar membranes 18 and a plurality of second bipolar membranes 24. In the electrode array 41, each first bipolar membrane 18 is disposed between a pair 44 of the first electrode 12 and a second electrode 14 (also referred to as a first electrode and second electrode pair 44) such that the first proton exchange layer 20 faces the second electrode 14 and the first anion exchange layer 22 faces the first electrode 12. Similarly, each second bipolar membrane 24 is disposed between a pair 46 of the second electrode 14 and the third electrode 16 (also referred to as a second electrode and third electrode pair 46) such that the second proton exchange layer 26 faces the third electrode 16 and the second anion exchange layer 28 faces the second electrode 14. In the flow battery stack 40, the at least one first electrode 12, the at least one second electrode 14, and the at least one third electrode 16 constitute at least one flow battery cell 10. In this configuration, each electrode (the first electrode 12, the second electrode 14, and the third electrode 16), except for the terminal electrodes, faces a bipolar membrane (the first bipolar membrane 18 or the second bipolar membrane 24) from both the sides. Further, as illustrated in FIG. 5, each first electrode 12 and third electrode 16, except for the terminal electrodes, may be shared in adjacent flow battery cells 10.

As described earlier with respect to the single cell 10 of FIG. 2, the stack 40 (as show in FIG. 5) includes a plurality of first chambers 30, a plurality of second chambers 32, and a plurality of third chambers 34. Each second electrode 14 and the first proton exchange layer 20 of the first bipolar membrane 18 (disposed adjacent to the second electrode 14) define the first portion 31 of a second chamber 32; and each second electrode 14 and the second anion exchange layer 28 of the second bipolar membrane 24 (disposed adjacent to the second electrode 14) define the second portion 33 of the second chamber 32. Further, the first electrode 12 and the first anion exchange layers 22 of the first bipolar membranes 18 disposed on both sides of the first electrode 12, define the first chamber 30. Similarly, the third electrode 16 and the second proton exchange layer 26 of the second bipolar membrane 24 disposed on both sides of the third electrode 16, define the third chamber 34.

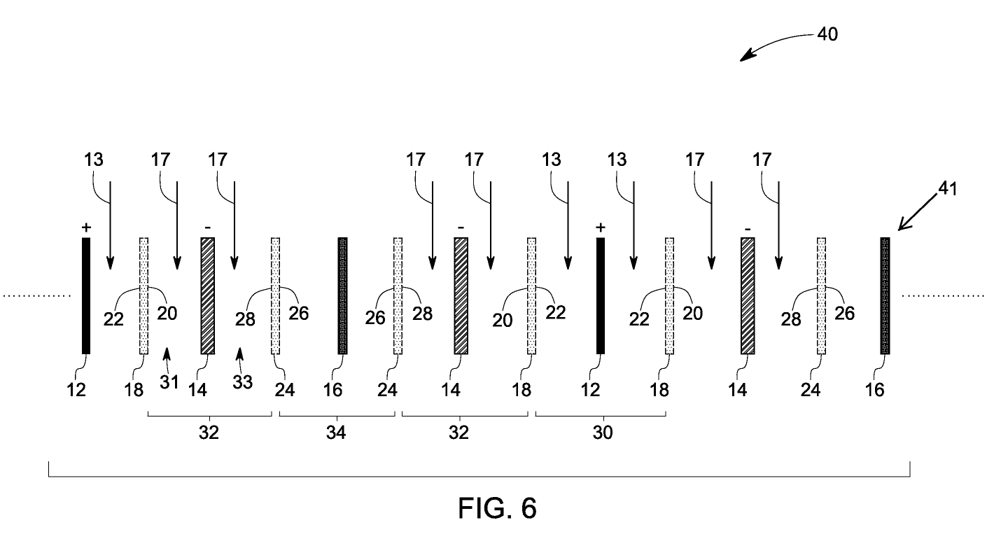

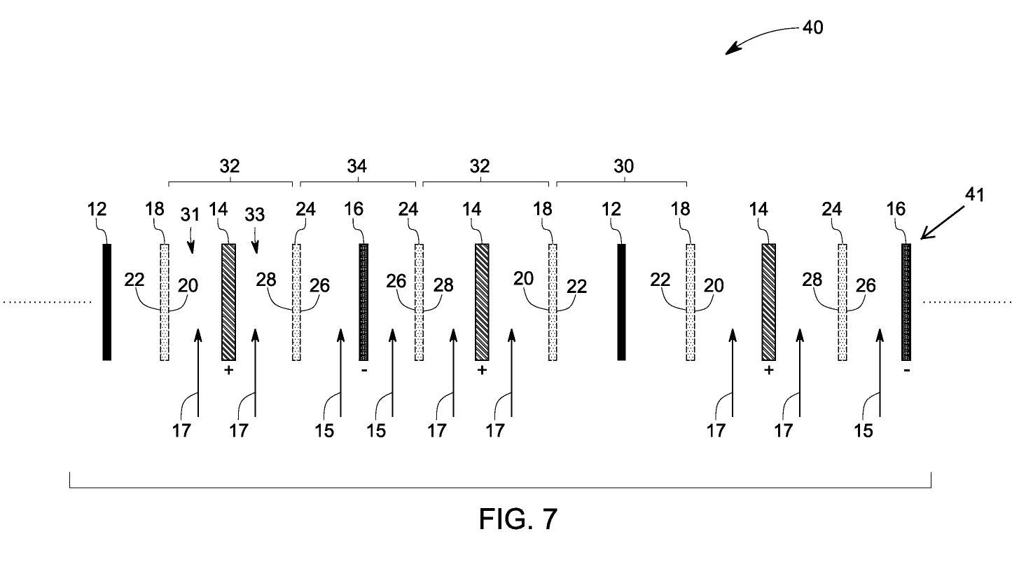

In some embodiments, as shown in FIGS. 6 and 7, the stack 40 further includes a discharged catholyte 13, a charged catholyte 15, an anolyte 17, or combinations thereof. In some embodiments, at least one first chamber 30 includes the discharged catholyte 13. In some embodiments, each first chamber 30 includes the discharged catholyte 13. In some embodiments, at least one second chamber 32 includes the anolyte 17. In some embodiments, each second chamber 32 includes the anolyte 17 14. In some embodiments, at least one third chamber 34 includes the charged catholyte 15. In some embodiments, each third chamber 34 includes the charged catholyte 15. As illustrated in FIGS. 5, 6 and 7, each first chamber 30 is separated from the adjacent second chamber 32 by the first bipolar membrane 18; and each third chamber 34 is separated from the adjacent second chamber 32 by the second bipolar membrane 24. In other words, the discharged and charged catholytes 13, 15 are separated from the anolyte 17, by the bipolar membranes 18, 24, respectively, in some embodiments.

Another embodiment of this invention is directed to a method of operating the flow battery stack 40 (as shown in FIG. 5). The method includes charging the flow battery stack 40 by contacting a discharged catholyte with at least one first electrode 12 in the plurality of first electrodes and an anolyte with at least one second electrode 14 in the plurality of second electrodes. The method further includes discharging the flow battery stack 40 by contacting the anolyte with at least one second electrode 14 in the plurality of second electrodes and a charged catholyte with at least one third electrode 16 in the plurality of third electrodes.

FIGS. 6 and 7 schematically show the battery stack 40 during charging and discharging, respectively, in accordance with embodiments. Referring to FIG. 6, during charging of the flow battery stack 40, the method includes contacting a discharged catholyte 13 with at least one first electrode 12 in the plurality of first electrodes and an anolyte 17 with at least one second electrode 14 in the plurality of second electrodes. In some embodiments (and as illustrated in FIG. 6), the discharged catholyte 13 is contacted with each first electrode 12 and the anolyte 17 is contacted with each second electrode of the flow battery stack 40. In some such instances, the discharged catholyte 13 flows through the plurality of first chambers 30 and the anolyte 17 flows through the plurality of second chambers 32 during charging of the flow battery stack 40. In some of these embodiments, the charged catholyte 15 is not provided in the plurality of third chambers 34. In some instances, the plurality of third electrodes 16 remains idle. Furthermore, in some embodiments, the halide-to-halate reaction occurs in the plurality of first chambers 30; and the metal ions are converted to the respective metal in the plurality of second chambers 32.

When the battery stack 40 is discharged as shown in FIG. 7, the method includes contacting the anolyte 17 with at least one second electrode 14 in the plurality of second electrodes and contacting the charged catholyte 15 with at least one third electrode 16 in the plurality of third electrodes. In some embodiments, the anolyte 17 is contacted with each second electrode 14 and the charged catholyte 15 is contacted with each third electrode 16. That is, the charged catholyte 15 flows in the plurality of third chambers 34 and the anolyte 17 flows in the plurality of second chamber 32. In some of these embodiments, the discharged catholyte is not provided in the plurality of first chambers 30. In some instances, the plurality of first electrodes 12 remains idle. In these embodiments, the halate-to-halide reaction occurs in the third chambers 34, and the metal is dissolved into a corresponding salt (halide salt) at the anolyte 17 in the second chambers 32.

Those skilled in the art understand that the battery stack 40 may include various other features and components in addition to the components described above. Non-limiting examples of additional components include current collectors, electrolyte storage tanks, and a casing. The discharged catholyte, the charged catholyte and anolyte storage tanks may be arranged in communication (e.g., liquid communication), respectively, with the plurality of first electrodes, the plurality of third electrodes, and the plurality of second electrodes. Other features of the flow battery stack may include pumps (not shown) for circulating the catholyte and anolyte solutions through the stack, via tubes or conduits. Conventional pumps can be used. Other methods for circulating the solutions are also possible, e.g., gravity-based systems.

Other examples of features and devices for the battery include sensors for pH monitoring, pressure measurement and control, gas flow, temperature, and the like. Batteries of this type will also include associated electrical circuitry and devices, e.g, an external power supply; as well as terminals for delivering battery output when necessary.

As mentioned above, in some embodiments, the flow batteries as described herein may be used as part of an electrical grid system, i.e., an interconnected network for delivering electricity from suppliers to consumers. For example, multiple flow batteries can be interconnected by known techniques, to allow storage of electricity on a large scale within the power grid. Those involved with electrical power generation on a commercial scale are familiar with various other features of the grid, e.g., power generation stations, transmission lines, and at least one type of power control and distribution apparatus. The flow batteries described herein may be able to provide the increased energy density, along with low battery costs, which may make them an attractive alternative for (or addition to) other types of grid storage units or systems, in accordance with some embodiments.

The flow batteries described herein can also be used for electrical vehicles, trucks, ships, and trains, as well as for other applications, such as submarines and airplanes. Electric vehicles include electric cars and hybrid electric cars. In some embodiments, the flow batteries could be incorporated as part of an electric powertrain, alone or supporting an internal combustion system. The flow batteries could also be used as independent electric source for the vehicle, e.g., for lighting, audio, air conditioning, windows, and the like.

Those skilled in the art are familiar with battery pack designs suitable for a given type of EV; as well as techniques for incorporating the battery into the drivetrain or other systems of the vehicle. As alluded to previously, the flexibility of the flow battery, including the ability to locate catholyte and anolyte sources in different places of the vehicle, may represent a considerable design advantage. The benefits of increased energy density arising from use of the halogen oxoacid salts may also enhance the battery profile of the electric vehicle or other device.

It should be understood that the battery configuration and design, as described herein, are not limited to flow batteries, and it will be understood that the descriptions and figures are not limited to metal halate flow batteries. The embodiments described herein may be utilized for any catholyte-anolyte chemistry that includes the proton generation and consumption, or requires pH control. Further, the embodiments described herein may be utilized for an electrochemical cell configuration, where charging and discharging require different electrode materials.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A flow battery cell, comprising:
a first electrode configured for charging a discharged catholyte;
a second electrode configured for charging and discharging an anolyte;
a third electrode configured for discharging a charged catholyte, wherein the second electrode is disposed between the first electrode and the third electrode;
a first bipolar membrane disposed between the first electrode and the second electrode; and
a second bipolar membrane disposed between the second electrode and the third electrode.

2. The flow battery cell of claim 1, wherein during discharging the flow battery cell, the charged catholyte is present in the flow battery cell such that the charged catholyte comprises one or more salts of halogen oxoacids.

3. The flow battery cell of claim 2, wherein the one or more salts of halogen oxoacids comprises a chlorate salt selected from the group consisting of sodium chlorate, potassium chlorate, lithium chlorate, calcium chlorate, magnesium chlorate, barium chlorate, zinc chlorate, copper (II) chlorate, and combinations thereof.

4. The flow battery cell of claim 1, wherein during charging the flow battery cell, the anolyte is present in the flow battery cell such that the anolyte comprises an aqueous solution of a metal salt.

5. The flow battery cell of claim 4, wherein the metal salt comprises a zinc salt, a cobalt salt, a copper salt, an iron salt, a manganese salt, a chromium salt, a vanadium salt, a titanium salt, or combinations thereof.

6. The flow battery cell of claim 1, wherein the first bipolar membrane comprises a first proton exchange layer and a first anion exchange layer, and the first bipolar membrane is disposed in the flow battery cell such that the first electrode and the first anion exchange layer define at least a portion of a first chamber, and the second electrode and the first proton exchange layer define a first portion of a second chamber.

7. The flow battery cell of claim 1, wherein the second bipolar membrane comprises a second proton exchange layer and a second anion exchange layer, and the second bipolar membrane is disposed in the flow battery cell such as the second anion exchange layer and the second electrode define a second portion of the second chamber and the second proton exchange layer and the third electrode define at least a portion of a third chamber.

8. The flow battery cell of claim 1, wherein a composition of the first electrode and the third electrode is the same.

9. The flow battery cell of claim 1, wherein a composition of the first electrode and the third electrode is different.

10. The flow battery cell of claim 1, wherein at least one of the first electrode and the third electrode comprises ruthenium oxide, tantalum oxide, lead oxide, titanium oxide, or combinations thereof.

11. A flow battery stack, comprising:
an electrode array, comprising:
a plurality of first electrodes configured for charging a discharged catholyte;
a plurality of second electrodes configured for charging and discharging an anolyte;
a plurality of third electrodes configured for discharging a charged catholyte;
wherein each first electrode in the plurality of the first electrodes is disposed in an alternating manner with respect to each third electrode in the plurality of the third electrodes, and
wherein each second electrode in the plurality of second electrodes is disposed between a first electrode and a third electrode pair;
a plurality of first bipolar membranes, wherein each first bipolar membrane in the plurality of the first bipolar membranes is disposed between a first electrode and a second electrode pair in the electrode array; and
a plurality of second bipolar membranes, wherein each second bipolar membrane in the plurality of second bipolar membranes is disposed between a second electrode and a third electrode pair in the electrode array.

12. The flow battery stack of claim 11, wherein during discharging the flow battery stack, the charged catholyte is present in the flow battery stack such that the charged catholyte comprises one or more salts of halogen oxoacids.

13. The flow battery stack of claim 12, wherein the one or more salts of halogen oxoacids comprises a chlorate salt selected from the group consisting of sodium chlorate, potassium chlorate, lithium chlorate, calcium chlorate, magnesium chlorate, barium chlorate, zinc chlorate, copper (II) chlorate, and combinations thereof.

14. The flow battery stack of claim 11, wherein during charging the flow battery stack, the anolyte is present in the flow battery stack such that the anolyte comprises an aqueous solution of a metal salt.

15. The flow battery stack of claim 14, wherein the metal salt comprises a zinc salt, a cobalt salt, a copper salt, an iron salt, a manganese salt, a chromium salt, a vanadium salt, a titanium salt, or combinations thereof.

16. A method for operating a flow battery stack, wherein the flow battery stack comprises:
an electrode array, comprising:
a plurality of first electrodes configured for charging a discharged catholyte;
a plurality of second electrodes configured for charging and discharging an anolyte;
a plurality of third electrodes configured for discharging a charged catholyte;
wherein each first electrode in the plurality of the first electrodes is disposed in an alternating manner with respect to each third electrode in the plurality of the third electrodes, and
wherein each second electrode in the plurality of second electrodes is disposed between a first electrode and a third electrode pair;
a plurality of first bipolar membranes, wherein each first bipolar membrane in the plurality of the first bipolar membranes is disposed between a first electrode and a second electrode pair in the electrode array; and
a plurality of second bipolar membranes, wherein each second bipolar membrane in the plurality of second bipolar membranes is disposed between a second electrode and a third electrode pair in the electrode array;
the method comprising:
charging the flow battery stack by contacting the discharged catholyte with at least one first electrode in the plurality of first electrodes and the anolyte with at least one second electrode in of the plurality of second electrodes; and
discharging the flow battery stack by contacting the anolyte with at least one second electrode in the plurality of second electrodes and the charged catholyte with at least one third electrode in the plurality of third electrodes, wherein the at least one first electrode, the at least one second electrode, and the at least one third electrode constitute at least one flow battery cell in the flow battery stack.

17. The method of claim 16, wherein the step of charging comprises contacting the discharged catholyte with each first electrode in the plurality of first electrodes and the anolyte with each second electrode in of the plurality of second electrodes.

18. The method of claim 16, wherein the step of discharging comprises contacting the anolyte with each second electrode in the plurality of second electrodes and the charged catholyte with each third electrode in the plurality of third electrodes.

19. The method of claim 16, wherein during the step of discharging of the flow battery stack, the charged catholyte that is contacted with at least one third electrode in the plurality of third electrodes, is present in the flow battery stack such that the charged catholyte comprises one or more salts of halogen oxoacids.

20. The method of claim 16, wherein during the step of charging of the flow battery stack, the anolyte is present in the flow battery stack such that the anolyte comprises an aqueous solution of a metal salt, wherein the metal salt is selected from a group consisting of a zinc salt, a cobalt salt, a copper salt, an iron salt, a manganese salt, a chromium salt, a vanadium salt, a titanium salt, or combinations thereof.
